(19) United States
(12) Patent Application Publication
(10) Pub. No.: US 2024/0017434 A1
(43) Pub. Date: Jan. 18, 2024

(54) DIGITAL COMMUNICATION ON RAZOR CARTRIDGE, HANDLE AND CHARGING BASE

(71) Applicant: Louis D. Tomassetti, Pompano Beach, FL (US)

(72) Inventor: Louis D. Tomassetti, Pompano Beach, FL (US)

(21) Appl. No.: 18/373,730

(22) Filed: Sep. 27, 2023

Related U.S. Application Data
(63) Continuation-in-part of application No. 16/845,287, filed on Apr. 10, 2020.
(60) Provisional application No. 62/832,007, filed on Apr. 10, 2019.

(51) Int. Cl. B26B 21/40; B26B 21/52; B26B 21/22

(52) U.S. Cl. CPC B26B 21/4056; B26B 21/521; B26B 21/225; B26B 21/4087; B26B 21/526; H04W 4/80

(57) ABSTRACT

A razor includes a blade cartridge with multiple blades that removably and pivotally attaches to a handle. The blade cartridge and handle include electronic processing elements for collecting, receiving, processing, storing and transferring data before, during and after use of the razor for shaving. A charging base allows for charging a rechargeable power source in the handle and is further adapted to communicate with a smartphone, computer or other electronic device via wired and/or wireless communication. The processing elements in the blade cartridge and the handle bidirectionally communicate with each other and the charging base including sending and receiving the data therebetween.

This non-provisional patent application is a Continuation-In-Part (CIP) of non-provisional patent application Ser. No. 16/845,287 filed on Apr. 10, 2020, which is based on provisional patent application Ser. No. 62/832,007 filed on Apr. 10, 2019.

### BACKGROUND OF THE INVENTION

### Field of the Invention

The present invention relates to razors for shaving and, more particularly, to a wet shave razor having one or more processing elements for collecting, storing and wirelessly transferring data.

### Discussion of the Related Art

Razors for shaving, and particularly wet shave razors, have been known and in use by a large percentage of the world population for many years. And, while there have been continued improvements made to razors over the years, the shaving industry has not seen any significant technological improvements to wet shave razors. Even electric razors have not been improved to any significant degree over the last 30 years.

In todays age of wireless communication, smart technology and artificial intelligence, the current state of the art in shave technology is antiquated to say the least. Simple implements, such as glide strips, multiple blades, pivoting action of the blade cartridge and ergonomically shaped handles are touted by razor manufacturers as the latest advancements, making their razors the best a customer can buy in the marketplace. And yet compared to the technology currently available in other industries, the most expensive wet shave razors and electric shave razors in stores today seem old-fashioned and outdated.

Accordingly, there remains an urgent need in the shaving industry for a technologically advanced razor that provides the most up-to-date electronic and wireless technology to best serve the modern consumer.

### SUMMARY OF THE INVENTION

The present invention is directed to a razor that has electronic processing elements that are capable of bidirectional wireless communication and structured for collecting, receiving, storing, processing and transferring data before, during and after use of the razor for shaving. The razor includes a blade cartridge with multiple blades that removably and pivotally attaches to a handle. A first processing element embedded within the blade cartridge allows for unique identification of the cartridge, as well as providing for memory to store data. The first processing element collects, receives, stores, processes and transfers data before, during and after use of the razor. The handle of the razor includes a second processing element that allows for bidirectional communication with the first processing element on the blade cartridge, as well as bidirectional communication between the handle and a charging base. The handle further contains a rechargeable power source. The razor is placed on a charging base to charge the rechargeable power source in the handle and/or blade cartridge. The charging base is structured to communicate with a smartphone, computer or other electronic device via wireless communication. A microphone in the handle allows for measuring noise of the blade cartridge traveling over the skin surface to calculate wearing of the blades. By sharing this data with a cloud-based service, a notification can be sent to the user indicating that it is time to replace the blade cartridge.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view, shown schematically, and illustrating one embodiment of the razor and charging base of the present invention;

FIG. 2 is a side elevational view, shown schematically, and illustrating the razor and charging base of FIG. 1 and further illustrating communication between the charging base and a smartphone and a computer which communicate and transfer data to a remote server, a cloud-based service and/or the Internet;

FIG. 3 is a side elevational view, shown schematically, and illustrating a further embodiment of the razor of the present invention; and

FIG. 4 is a side elevational view, shown schematically, and illustrating a further embodiment of the charging base including a cover and a heater for heating the blades.

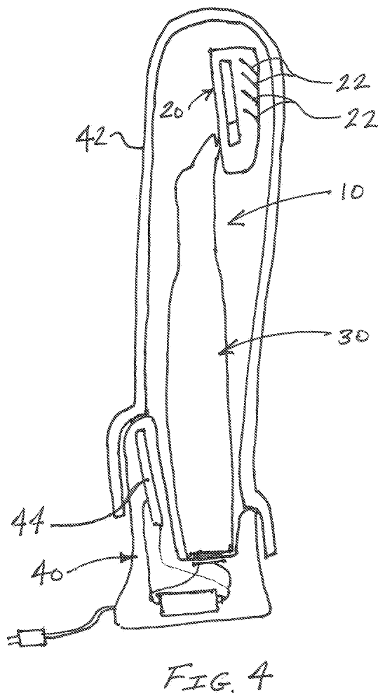

Like reference numerals refer to like parts throughout the several views of the drawings.

### DETAILED DESCRIPTION OF THE PREFERRED EMBODIMENTS

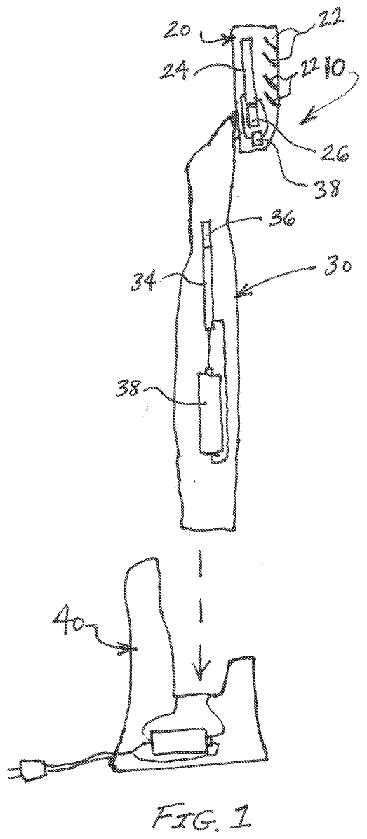

Referring to the several views of the drawings, the razor of the present invention is shown schematically and is generally indicated as 10. The razor 10 has a blade cartridge 20 that includes at least one blade 22 and preferably multiple blades 22. The razor cartridge is pivotally and removably attached to a handle 30. The razor 10 includes electronic processing elements for collecting, storing and transferring data. In one embodiment, as shown in FIG. 1, the blade cartridge 20 includes a processing element 24 that uses near field NFC (near field communication) and/or RFID (radiofrequency identification). The processing element 24 is embedded into the cartridge 20 and allows for unique identification of the cartridge 20 as well as memory. The processing element 24 has an NFC chip 26. The handle 30 of the razor 10 also includes a processing element 34 with an NFC communication chip 36 as well for wireless communication with the processing element 24 in the blade cartridge. Additionally, a wireless charger device 40 (i.e., charging base) allows for bidirectional communication between the processing elements 24 and 34 in the blade cartridge 20 and the handle 30 and the charging base 40. This provides for the ability to synchronize data between the blade cartridge 20, the handle 30 and the charging base 40.

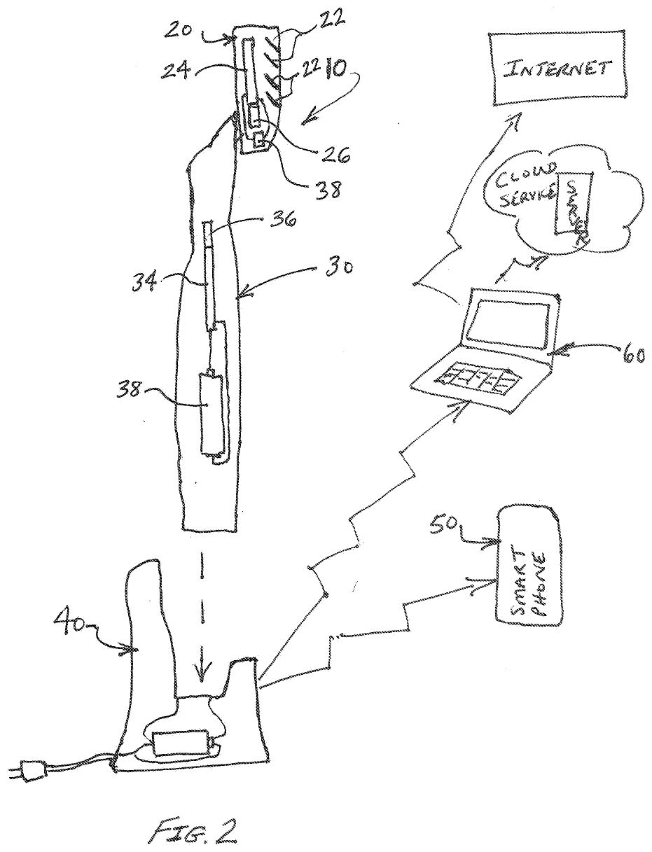

In a further embodiment, as shown in FIG. 2, the charging base 40, in addition to providing the function of a wireless charger for charging a power source 38 in the handle 30 and/or blade cartridge, also includes wired and/or wireless communication components and functionality to allow wireless communication with the processing elements 24 and 34, as well as a smart phone computer 60 or other electronic device. The smart phone 50 will have a computer application (i.e., mobile app) to communicate with the charging base 40 (“smart base”), while also providing a means for wired or wireless communication with remote servers/cloud infrastructure and/or the Internet. In another embodiment, the handle communicates with the smart phone directly via low energy wireless communication.

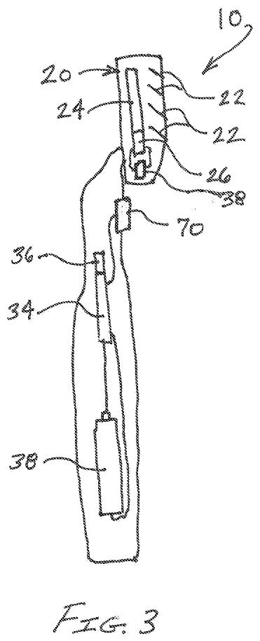

In yet a further embodiment, as seen in FIG. 3, a microphone 70 is provided in the handle of the razor 10. The microphone 70 receives noise as the user shaves. As the blades 22 move along the skin surface, the cutting of the hairs creates a noise. By measuring the envelope of the noise, as well as the frequency of the noise/pitch of the noise, the speed of the shaving strokes can be determined. Knowing the speed of the shaving strokes and the time that each stroke takes, the distance of travel of the blades 22 across the skin surface is easily calculated. The calculated distance is metered (i.e., added to the sum total of previously calculated shaving stroke distances) for each blade cartridge. By sharing this data with a cloud-based service, a notification can be sent to the user of the razor 10 indicating that the cartridge 20 (i.e., useful life of the blades) has expired or is about to expire, along with instructions that the user will need to replace the blade cartridge to ensure a smooth shave. This data is also sent to the processing elements 24 and 34, either directly or from the charging base 40.

This allows a razor supply service to trace the supply chain. Because each cartridge has a unique ID, by having the database of those cartridges beforehand, the supply service can always trace them to the end user. This allows a lot of insight to the supply chain and to the shaving habits of the user. For example, a smart phone application can trace how often the user shaves and can remind the user when they need a shave.

Additionally, the user can re-order the blade cartridges either automatically via the smart phone application or manually. Since each blade cartridge has a unique ID, each blade cartridge can be identified to a specific user. The user can then be alerted if they are about to use someone else's blade cartridge, which may be beneficial for sanitary reasons.

The processing element 24 on the blade cartridge is structured and adapted for collecting, receiving, storing, processing and transferring data before, during and after use of the razor. More particularly, before shaving, the processing element 24 is provided with a particular identification that is stored in its memory. Additionally, a power and temperature curve is programmed and stored in the memory of the first processing element 24. The power and temperature curve is specific to the particular blade cartridge and blades and sets forth how much milliwatts need to be applied to the blades in order to achieve a particular temperature which may be identified as the ideal or desired temperature of the blades for shaving. The power and temperature curve also sets forth the thermal capacity of the blades which is also needed for determining the correct amount of milliwatts to be applied to the blades for heating to the desired temperature. Additionally, the total area shaved to date is stored in the memory of the first processing element 24 before each shave, as measured by the microphone 70, described above. Further, the last handle identification (e.g., ID code) used is stored in the memory of the first processing element 24 before each shave. It should be noted that each handle 30 has a specific ID and that ID is sent from the second processing element 34 to the first processing element 24 when the handle 30 is attached to the blade cartridge 20. Moreover, the average shaving session duration is determined by either the second processing element 34 or the first processing element 24 and is stored in the first processing element 24 before each shave. Additionally, the maximum remaining area that can be shaved with a particular blade cartridge 20 while maintaining the desired blade sharpness is stored in the memory of the first processing element 24 before each shave.

During shaving, the first processing element 24 receives and stores the total area being shaved in real time. Additionally, the total power applied to the blades and how many milliwatt hours that have been consumed to heat the blades is constantly updated in real time and this data is received and stored in the memory of the first processing element 24 on the blade cartridge 20.

After each shave, the total area shaved to date is updated and stored in the processing element 24. Additionally, the handle ID is stored in the memory of the processing element 24, as well as other parameters.

Much like the first processing element 24, the second processing element 34 is structured and adapted for collecting, receiving, storing, processing and transferring data before, during and after use of the razor. Before use of the razor, the second processing element 34 acquires various parameters from the first processing element 24 on the blade cartridge, as described above.

During shaving, the second processing element 34 continually receives and stores data from sensors including, but not limited to, a temperature sensor and the microphone 70. Additionally, the second processing element 34 regulates the power applied to the blades during shaving to maintain the desired temperature of the blades. Moreover, the second processing element 34 performs algorithmic processing of the sensor data information including, but not limited to, the temperature sensor data and the microphone data. Throughout the shaving process, the second processing element 34 and the first processing element 24 communicate with each other in a bidirectional manner to constantly collect, receive, store, process and transfer data. The second processing element 34 continually communicates with a battery management system to monitor the power being consumed, as well as the remaining battery power. During the shaving process, the second processing element 34 also calculates new parameters for the shaving system.

After shaving, the second processing element 34 communicates with the first processing element 24 on the blade cartridge, as well as with the battery management system to update the remaining power of the battery before recharging is necessary. The second processing element 34 further determines whether the razor is in either a sleep mode or a charge cycle. More specifically, if the razor is put down on a counter, the second processing element 34 determines that the battery is not being recharged, and the second processing element 34 sends a signal to the battery management system to shut down power and to enter a sleep cycle. Alternatively, if the razor is placed on the charger base, the second processing element 34 determines that the battery is being recharged on the charger base and thereby opens up a new communication for charging in order to start the charging process of the battery.

It is important to note that the memory in the first processing element 24 on the blade cartridge is constantly updated throughout the lifecycle of the blade cartridge 20, from the time of manufacture, throughout use of the blade cartridge and up to the time of disposal.

In addition to communication, at least one embodiment of the charging base 40 can have HMI (human machine interface). Additionally, the blade cartridges 20 can be heated to sanitize the blades 22 and anneal the blade material because when the blade material is annealed you have better cutting properties. If the charging base 40 is provided with a heater device 44 and is covered, we can controllably heat up/overheat the blades 22 to sanitize the blades 22 by killing the bacteria above 180-200 degrees Fahrenheit (the blades 22 and cartridge 20 could potentially be heated to 300 degrees Fahrenheit because the plastic would not melt up to this temperature). This will prolong the life of the blades 22.

Annealing the metal: aligning all the lattices in the metal. When the metal blades 22 are heated (e.g., above 200 degrees Fahrenheit) and then slowly cooled down, all the lattices in the metal in the structure are aligned, instead of being randomly arranged. The benefit of the lattices aligned is better cutting properties. Instead of being jagged edges on the blade 22, you have smooth edges. Another benefit is it helps to make the blades 22 last longer. Annealing softens it slightly so the lattices will be aligned. Another benefit of heating the blades 22 is killing the bacteria to thereby sanitize the blades and burn away whiskers, skin and oils that remain on the blades surfaces after shaving. This may require heating the blades 22 to 350-400 degrees Fahrenheit. To protect the user, the cover 42 of the charging base 40 can be provided with a safety mechanism which will prevent removal of the cover 42 when the blades 22 are above a certain temperature.

While the present invention has been shown in accordance with several preferred and practical embodiments, it is recognized that departures from the instant disclosure are fully contemplated within the spirit and scope of the present invention which is not to be limited except as defined in the following claims as interpreted under the Doctrine of Equivalents.

What is claimed is:

1. A razor system comprising:
a handle;
a blade cartridge pivotally and removably attachable to the handle and including a plurality of blades;
a first processing element in the blade cartridge for collecting, receiving, storing, processing and transferring data before, during and after use of the razor system for shaving, and the first processing element uniquely identifying the blade cartridge and the data;
a second processing element in the handle for collecting, receiving, storing, processing and transferring data before, during and after use of the razor system for shaving, and the first processing element and the second processing element both structured for bidirectionally communicating with each other including sending and receiving the data therebetween;
a rechargeable power source in the handle for powering at least the second processing element; and
a charging base structured for wireless charging of the rechargeable power source.

2. The razor system as recited in claim 1 wherein the first processing element and the second processing element communicate with each other bidirectionally using near field communication.

3. The razor system as recited in claim 2 wherein the first processing element includes a near field communication chip and the second processing element includes a near field communication chip, and the near field communication chips allowing wireless bidirectional communication between the first and second processing elements, including transferring and receiving the data, and processing and storing the data.

4. The razor system as recited in claim 3 wherein the charging base is structured and disposed for wirelessly and bidirectionally communicating with the first processing element in the blade cartridge and the second processing element in the handle.

5. The razor system as recited in claim 4 wherein the charging base is further structured and disposed for communicating with an electronic computer device.

6. The razor system as recited in claim 5 wherein the electronic computer device communicates with a remote server.

7. The razor system as recited in claim 5 wherein the electronic computer device communicates with a cloud-based service.

8. The razor system as recited in claim 5 wherein the electronic computer device communicates with the Internet.

9. The razor system as recited in claim 5 wherein the electronic computer device is a smartphone.
